(19) United States
(12) Patent Application Publication
(10) Pub. No.: US 2002/0017435 A1
(43) Pub. Date: Feb. 14, 2002

(54) Full disk brake for road vehicles

(76) Inventors: Joachim Feldmann, Neustadt (DE); Marc Bodet, Northen (DE); Paul Antony, Worms (DE)

Correspondence Address: Proskauer Rose LLP, Patent Department, 1585 Broadway, New York, NY, 10036, US

(21) Appl. No.: 09/911,771

(22) Filed: Jul. 24, 2001

(30) Foreign Application Priority Data
Aug. 8, 2000 (DE) 100 38 490.0

(51) Int. Cl. F16D 55/02

(52) U.S. Cl. 188/71.6; 188/71.1

(57) ABSTRACT

A full disk brake for a vehicle includes a rotor disk, which is attached to the vehicle wheel. Two friction disks are installed within a brake-clamping unit, facing each side of the rotor disk. The friction disks are secured in the direction of rotation, but are capable of being shifted in an axial direction. Brake lining segments are attached to both sides of the rotor disk. When the brake-clamping unit is actuated, a friction connection is established between the rotor disk and the friction disks. Air cooling channels, located between the brake lining segments, provide cooling air between the rotor disk and the friction disks directly at the point of origination. Moreover, the brake lining segments act as heat-insulating elements between the friction disks and the rotor disk, thus further reducing the heating of the rotor disk.

### BACKGROUND OF THE INVENTION

The present invention relates to a full disk brake for road vehicles. More specifically, the present invention relates to a full disk brake arrangement with built-in air cooling channels to reduce the frictional heat generated in the braking process.

A full disk brake of this type is known in the art from U.S. Pat. No. 3,830,345 (Boyles, Aug. 20, 1974, incorporated herein by reference).

In this patent, two brake shoe units of the same type are installed in two housing units, and are placed on opposite sides of a brake disk 36 to exert uniform force.

The brake disk 36 is connected to a wheel hub 12 of a vehicle wheel. Two brake lining elements 42 are mounted on both sides of the brake disk 36, and follow its form, i.e., ring-shaped.

Brake clamping takes place via a pair of brake shoes 46, which can be moved against the brake disk 36, since the brake shoes 46 are installed on either side of the brake disk 36. For this purpose, the brake shoes 46 are subjected to a force from fluid-actuated hoses 64 by a pair of movable pistons 60, which are in a ring-shaped configuration, in order to establish frictional engagement with the brake disk 36.

Cooling ribs 80 are provided on the surfaces of the brake shoes 46, away from the brake disk 36, to serve as a first cooling means, using the surrounding air. Cooling ribs 82 are provided as a second cooling means in the open area of a brake shoe.

The brake lining elements are made of a metallic, or other highly heatconductive material, so that the frictional heat is transmitted efficiently to the brake shoes.

Another prior art brake arrangement is disclosed in PCT patent document WO 98/55776 (Didier et al, Dec. 11, 1998, incorporated herein by reference). Here, the disk brake has a rotor disk 20, which is rotatably connected to a wheel to be braked. In addition, two axially movable stator disks 30, 40 are included, which are nonrotatable relative to the vehicle axle. The surfaces of the rotor disk 20 and the surfaces of the stator disks 30, 40 face each other, and constitute frictional surfaces. Due to the force of the stator disks 30, 40 acting upon the rotor disk 20, a braking action is generated against rotor disk 20, and the axial force is absorbed by a contacting device 80. The stator disks 30, 40, and rotor disk 20 are in the form of coaxial rings, and are made of a thermostructural material. Also, coaxial, ring-shaped friction linings made of a different thermostructural material are provided at least in the area of the frictional surfaces. To ensure against rotation, rotation-prevention elements 36 are provided on a stator disk, on the side away from the rotor, to act together with complementary elements 64 upon the contact devices. These rotation-preventing elements are designed so that air chambers 66 are created on the delimiting surfaces, away from the rotor disk, to contribute to the ventilation of the brake. Cooling means in the form of air channels of various designs (e.g., as in FIG. 14) are provided in the interior of the rotor disk. For cooling purposes, this patent provides for the frictional heat to be diverted from the point at which it is generated, either to the air channels in the rotor disk, or through the stator disks for convection cooling. Thus, cooling takes place indirectly, and the structural elements traversed by the heat flow are heated to a considerable degree. This arrangement suffers from a further disadvantage, especially in the case of strong braking, in that an uneven surface pressure occurs due to the elastic deformation of the guiding device 50, causing the surface pressure to decrease considerably towards the inner diameter. As a result, disproportionate wear occurs at the outer diameter.

U.S. Pat. No. 5,205,380 (Paquet, et al, Apr. 27, 1993, incorporated herein by reference) discloses a full disk brake that can be configured as an operating brake, as well as a parking brake, or as a combination operating and parking brake. The brake disk of this full disk brake is provided with internal teeth, which interlock in a circumferential direction, but can be shifted in an axial direction. The brake disk is connected to a spline shaft, which is in turn connected interlockingly to the wheel to be braked 12. The wheel is rotatably connected via ball bearings 14 to the fixed axle 10 of the vehicle. The brake clamping system of the full disk brake is connected interlockingly to the axle. When the brake is actuated, the brake clamping system causes the ring-shaped brake linings 76, 38 on either side of the brake disk to be pressed against the brake disk, with a force proportional to the brake actuation, so that a frictionally interlocking connection between the brake linings and the brake disk is produced at the frictional surfaces 40, 80. The full disk brake is cooled via ventilation channels 43, through which the cooling air flows in radial directions in the brake disk. A disadvantage of this arrangement is that the frictional heat must be transferred from the frictional surfaces to the radial channels, which results in heating of the brake disk. Here too, elastic deformation results in a disproportionate wear on the outer diameter, as previously described.

German patent document DE-OS 27 46 758 (U.S. Pat. No. 4,102,438, Yvon, Jul. 25, 1978, incorporated herein by reference) discloses a brake disk construction with a different cooling channel design. This patent teaches a brake disk 53 with brake surfaces on either side connected interlockingly to the wheel of a vehicle 12, but movable to a limited extent in an axial direction. On either side of the brake disk 53, non-rotatable, but axially movable brake shoes 88 are provided in the brake housing. These brake shoes 88 consist of a metallic brake shoe disk 89, with large, ring-shaped brake lining elements 97 attached on the side of the brake-disk. The expansion of fluid-actuated bladders 116, 117 causes the brake shoe disks 89 to be actuated in such manner that the brake lining elements 97 come into frictional contact with the appertaining braking surfaces 56, 57 of the brake disk 53. Between the two walls of the brake disk 53, constituting the two braking surfaces, are several arc-shaped intermediate walls 80. These walls 80 are delimited by several channels, which are arranged radially, and spaced from each other. That is, these channels are interspersed at their inner ends 83 in the inner mantle 58, and at their outer ends 84 in the outer mantle 54 of the brake disk. These channels represent the cooling means for this brake arrangement. Between adjoining channel-separating walls, radial blades 86 directed to the inside are used to circulate air, and thereby to assist in the removal of heat. The channels are designed so that a negative pressure is produced at the outer circumferential surface of the brake disk. This negative pressure causes cooling air to be sucked into the brake housing in the area of the brake disk center. In one embodiment, the channels are designed in the form of outward diverging, arc-shaped channels 82, and their curvature is opposite to the direction of rotation of the brake disk in forward travel. In another embodiment, the channels are S-shaped 142, and they diverge to the outside, but their inlets 144 are oriented in the direction of rotation of the brake disk in forward travel. As in other prior art patents, the braking heat must be directed through the brake disk to the cooling channels, since the fluid-actuated bladders prevent a further path for heat removal. While the lining pressure is uniform in this arrangement, it is achieved at a comparatively high technical expenditure for two fluid-actuated bladders.

High temperatures can occur on the brake disks of heavy utility vehicles when the brakes are operated. Thus, disk brakes of this type are designed for a “worst case scenario ”, where, e.g., braking a fully loaded semi-trailer from 110 km/h to a complete stop can cause the disk temperature to reach 800° C. To cool a brake disk at this elevated temperature takes about 10 to 20 minutes, depending on the operating conditions.

The greatest temperature stress on brake disks is not due to braking to a stop, but rather, as a result of “adaptation braking”, as occurs, for example, when driving down a mountain over the serpentine curves of a pass. In this situation, the speed is reduced by means of the disk brakes for each serpentine turn (assuming an unwise, but realistically possible driving method). As such, adaptation brake applications take place at short time intervals, with no possibility for the brake disks to cool down between intervals. As experience shows, temperatures close to 1000° C. can occur when this type of braking is applied.

Referring again to U.S. Pat. No. 3,830,345, it is disclosed therein that the brake lining elements are made of a metallic, or other highly heat-conductive material, so that the frictional heat is transmitted efficiently to the brake shoes (column 2, lines 30-35). In this disclosure, the heated brake disk temperature is gradually reduced to ambient temperature via the highly heat-conductive brake lining elements and the brake disk.

However, when the brake disk is heated as stated, due to its normally high heat-conductivity, the wheel hub connected to the brake disk is also heated (see column 4, lines 30-35). If the wheel hub is excessively heated in this manner, e.g., above 120° C. the grease in the roller bearing rings of the wheel hub becomes a thin liquid, and is pressed to the outside by centrifugal force. This condition can result in a failure of the bearing lubrication properties, and thereby in damage to the wheel hub. If special seals and special grease are used for high temperature conditions, the danger exists that the wrong seals and grease may be used in performing maintenance, resulting in bearing failure.

It is therefore an object of the present invention to improve the heat dissipation characteristics of a full disk brake, in such manner that heat removal is improved without raising the wheel hub temperature.

### SUMMARY OF THE INVENTION

In accordance with an illustrative embodiment of the present invention, a full disk brake for braking a vehicle comprises:

a. a rotor disk, connected non-rotatably to a wheel of the vehicle, where the wheel is mounted rotatably on an axle of the vehicle;

b. brake-clamping unit, connected to the axle;

c. at least one friction disk, which is secured in a rotational direction within the brake-clamping unit, and which is capable of displacement in an axial direction;

d. at least one brake lining component, in the form of a separate mechanical part, which is installed non-rotatably within a ring-shaped area on the rotor disk; and

e. a cooling arrangement, located in an area between the rotor disk and the friction disk, so that when the brake-clamping unit is activated, cooling air is directed to the heat-producing area, caused by the interlocking friction connection taking place between the rotor disk and the friction disk.

In an alternate embodiment, the brake-clamping unit can be configured as a floating, orbiting saddle around the vehicle axle.

The one or more brake lining components are positioned in an area between the rotor disk and the friction disk.

The cooling arrangement of the inventive full disk brake is made up of a plurality of air cooling channels, which are configured as recesses in the rotor disk. These air cooling channels are open to ambient air, and extend in the direction of the friction disk, such that the friction disk becomes a delimitation surface for the air cooling channels.

One advantageous feature of the present invention is that certain parts subject to heating, e.g., the friction disks, are practically static; i.e., they are only capable of being shifted axially, and are not dynamically revolving. The invention has the further advantage that very little maintenance is required, due to the simple arrangement of the components.

Moreover, these heat-absorbing parts are not attached to the wheel hub, but are connected via a long heat-guiding path directly to the vehicle axle.

A further advantage of the invention is that the rotor disk is located between the friction disks, and is well protected, since the complete brake-clamping unit is encapsulated, and is therefore isolated from environmental influences, such as water and dust.

Another advantageous feature of the invention is that the brake lining segments connected to the rotor disk are relatively light, resulting in a comparatively low inertia moment for the rotor disk.

A further advantage of the invention is that the brake lining segments cover a large frictional surface area of the rotor disk, thus increasing the stability of the brake lining segments.

Moreover, the rotationally symmetrical brake-clamping unit produces an evenly distributed brake lining pressure via the friction disks, which is independent of the brake application force. This uniform force, distributed evenly over the friction surface, reduces wear of the rotor disk, so that the travel capacity between replacements of the rotor disk is increased.

As compared with prior art disk brake designs, where the rotating disk is composed of a combination of ceramic disk and steel hub, the present invention offers the advantage of a disk design which is oriented to ceramic technology.

### BRIEF DESCRIPTION OF THE DRAWINGS

The invention is described in greater detail below through the embodiments shown in the drawings, wherein

FIG. 1 shows the full disk brake in overview, subdivided into three partial views, as follows:

FIG. 1a shows the lateral view from the right;

FIG. 1b shows a section AA along the course drawn in FIG. 1c;

FIG. 1c shows a section BB along a course drawn in FIG.1b.

FIG. 2 is an enlarged view of FIG. 1b.

FIG. 3 is an enlarged view of FIG. 1c.

FIG. 4 shows an embodiment with the disk to be braked as a shiftable element.

FIG. 5 shows an embodiment in which brake lining segments are mounted on the disk to be braked, so as to be capable of axial displacement.

FIG. 6 shows the inventive disk in the form of a rotor disk, for the embodiment according to FIGS. 2 to 4, where the air guiding channels have straight lateral delimitation surfaces.

FIG. 7 shows the rotor disk for the embodiment according to FIGS. 2 to 4, where the air guiding channels are equipped with curved lateral delimitation surfaces.

FIG. 8 shows the rotor disk of the embodiment according to FIG. 5.

### DETAILED DESCRIPTION OF THE INVENTION

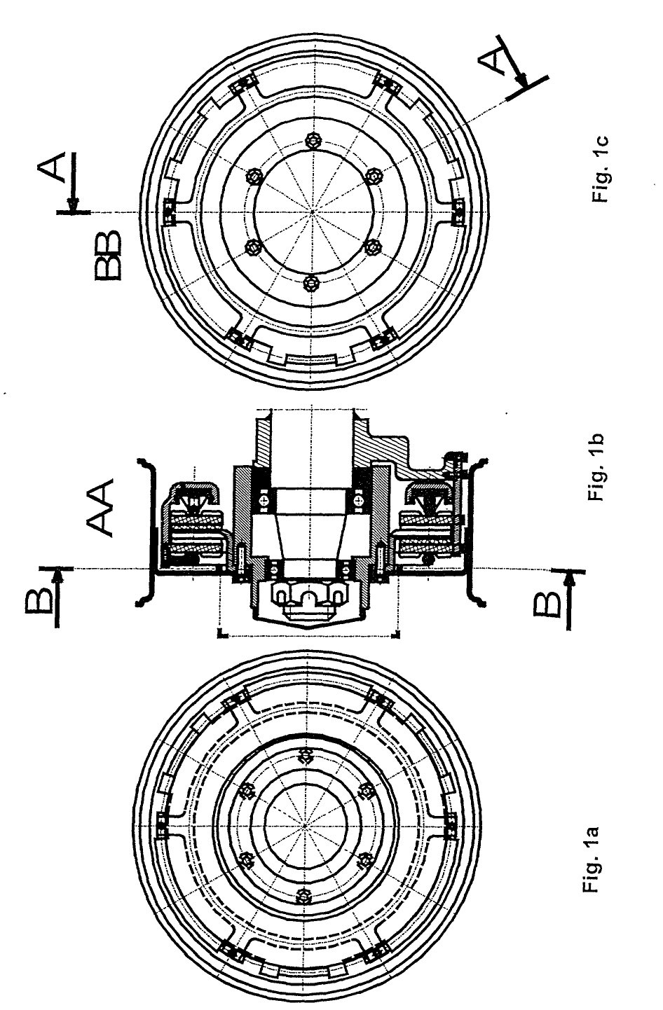

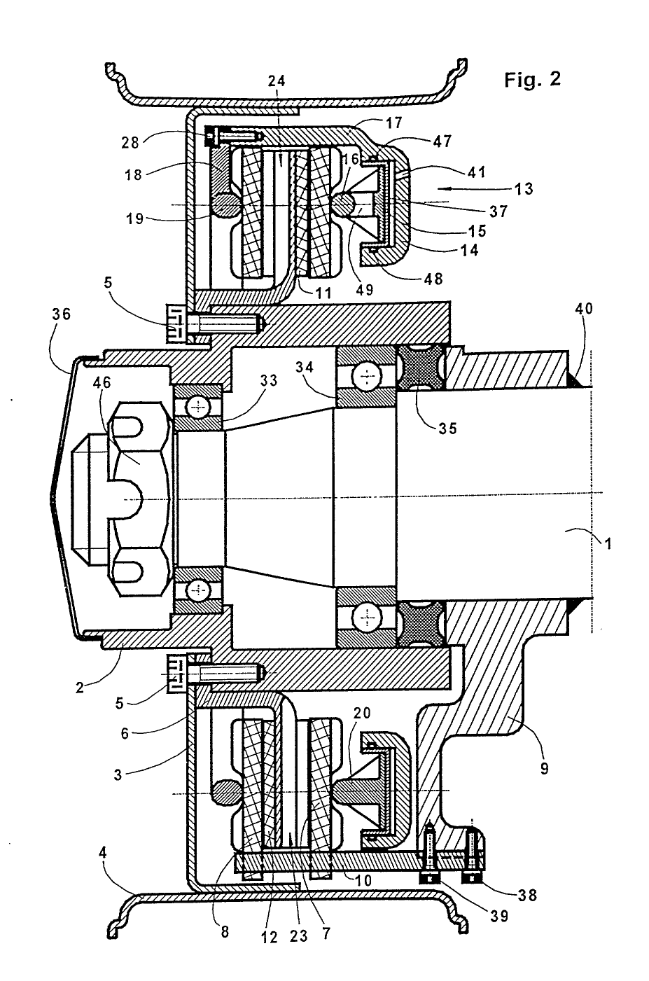

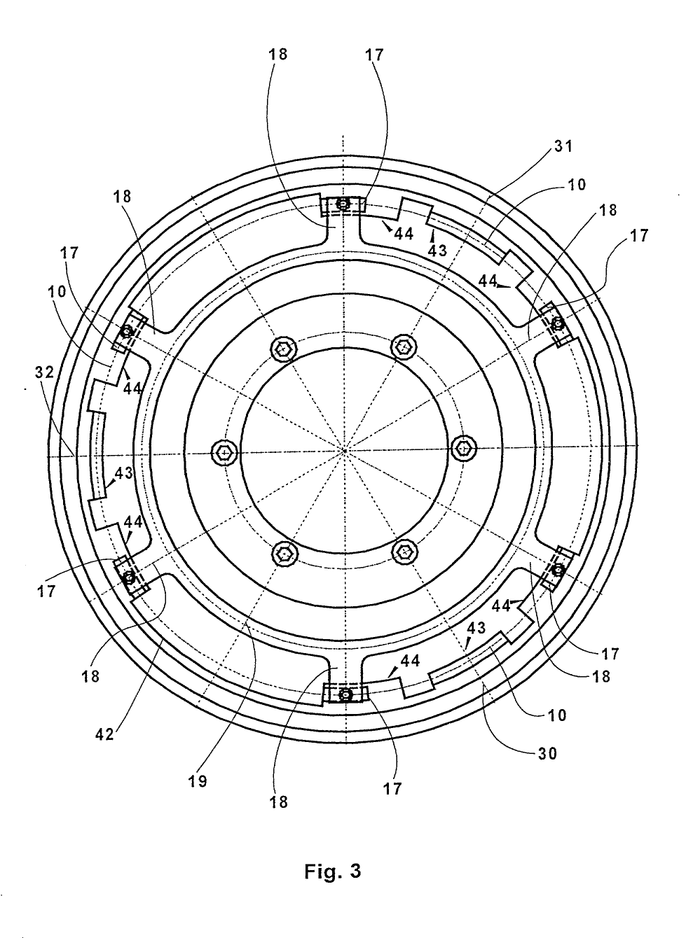

The overview of FIG. 1 shows the courses of the sections of FIGS. 2 and 3. The drawings in FIGS. 1a-1c are therefore shown in more detail in the enlarged drawings of FIGS. 2 and 3.

According to FIG. 2, the wheel hub 2 of a wheel 3 is connected in a fixed axial position to a vehicle axle 1 via a screw connection 46, but is rotatable relative to vehicle axle 1 by means of pivot bearings 33 and 34. The bearing area is sealed off by a seal 35 and a cover 36.

The wheel 3, together with its rim well 4, is connected to the wheel hub 2 via connection screws 5. A brake disk 6, in the form of a rotor disk, serves to brake the wheel 3, and is also affixed to the wheel hub 2 via connection screws 5.

A brake lining is typically configured in a basic ring-shaped configuration, and is non-rotatably connected to a brake disk. In the embodiment of FIG. 1, the brake linings are glued to the disk 6. In the direction of a first inner friction disk 7, to be described below, is the brake lining 11, and in the direction of a second outer friction disk 8, is the brake lining 12.

A ring-shaped holder is provided for the brake moment support and for brake clamping. This ring-shaped brake carrier holder 9 is interlockingly connected to the vehicle axle 1 via an attachment 40. Distributed over the circumference of the brake carrier holder 9, and offset relative to each other by 120 degrees, three brake carriers 10 (shown in FIG. 3 at angle positions 30, 31 and 32) are each permanently attached to the brake carrier holder 9 via screws 38 and 39. The brake carriers 10 are configured as cylindrical elements, with the cross-section of a circular-ring angle segment; i.e., a segment of a given angle cut out of a complete 360° circular ring.

To produce a frictional interlocking engagement with the rotor disk 6, a first inner friction disk 7 and a second outer friction disk 8 are provided. Both friction disks 7, 8 are configured as circular-ring disks, and are held in place by the brake carriers 10, in the direction of rotation relative to the vehicle axle 1. They are capable of being displaced in an axial direction, in order to press against the rotor disk 6. The three brake carriers 10 transmit the braking moment, which is produced between the rotor disk 6 to be braked and the friction disks 7, 8, to the vehicle axle 1.

The frictional interlocking engagement is produced by a brake-clamping unit 13, which transmits a brake application force perpendicular to the first and second friction disks 7, 8, and thereupon against the rotor disk 6.

The brake-clamping unit 13 is implemented as follows:

1) a hydraulic ring cylinder 14, the base surface of which is configured as a circular ring;

2) a piston chamber 37, within the hydraulic ring cylinder 14, having an annular cylindrical form to correspond to the basic form of the ring cylinder 14;

3) a valve system (not shown) which controls the flow of hydraulic liquid to and from the piston chamber 37 via a bore 41;

4) a ring piston 15, which includes an integrated force transmission ring 20, in order to introduce the brake application force;

5) a piston rod ring 16, attached to the transmission ring 20;

6) piston chamber seals 47, 48, for sealing the piston chamber 37;

7) six ring cylinder extension rods 17, which serve as traction elements, and are made with the cross-section of a circular-ring angle segment, as the extension of the outer mantle of the ring cylinder 14;

8) a force transmission ring 19, for the transmission of the brake application reaction force, which is equipped with six radial force transmission rods 18, each having a bore in the end segment of their radial extension; and

9) six fastening screws 28, to connect the force transmission rods 18 via their bores to the ring cylinder extension rods 17.

The force transmission ring 20, with the piston rod ring 16, has cooling-air openings 49 distributed along its circumference, in order to ensure thorough ventilation of the brake.

It should be noted here that the disclosed brake application using hydraulic ring cylinder extension rods 17 can also be replicated by a correspondingly equipped pneumatic cylinder. Moreover, it is also possible to design the inventive brake application system as a mechanical, or electric/mechanical, apparatus.

In the assembly of the brake-clamping unit 13, the ring cylinder 14 is joined to the ring piston 15, and is pressed via the ring cylinder extension rods 17 against the force transmission rods 18, whereupon all these elements are connected to each other by means of the fastening screws 28.

The assembled brake-clamping unit 13 is freely suspended over the axially non-displaceable rotor disk 6, and the radially non-moving friction disks 7, 8. As such, brake-clamping unit 13 represents a floating saddle orbiting by 360°, on which the lining wear is compensated for by the increased advance of the force transmission ring 20. A ventilation clearance resetting is achieved through the elastic design of the piston chamber seals 47, 48, as is known to a person schooled in the art. To equalize wear, the brake-clamping unit is displaced axially with the increased piston rod advance, in relation to the axially non-displaceable rotor disk 6. With increased wear, the brake linings 11, 12 become thinner, but the axial position of their friction surfaces does not change in relation to the vehicle axle 1.

The two friction disks, first friction disk 7 and second friction disk 8, are of identical form. In addition to their basic form as circular ring disks, they have at their outer limit two types of recesses, in the form of circular ring angle segments. In FIG. 3, this can be recognized on the visible outside contour 42 of the second outside friction disk 8.

A first type of circular ring disk segment opening is represented by the three recesses 43, as shown in FIG. 3, which is the enlarged drawing of FIG. 1c. FIG. 3 also shows that the outer limit surfaces of the segment recesses 43 are touching the lateral limit surfaces of the brake carriers 10 in a straight line, thus ensuring the prevention of rotation of the two friction disks 7, 8.

The six circular-ring angle segment recesses 44 represent a second type of recess. The centerlines of these recesses are respectively offset by ±30°, in relation to the angle positions 30, 31 and 32 of the brake supports.

FIG. 3 shows that the friction disks 7, 8 are inserted in such manner that the ring cylinder extension rods 17 alternately contact the left and right lateral limit surface of the circular-ring angle segment recesses 44. Attachment by means of the fastening screws 28 (FIG. 2) centers and assembles the brake-clamping unit 13, and the prevention of rotation of the friction disks 7, 8, relative to the brake-clamping unit 13, is ensured in both directions of rotation.

In order to mount the wheel 3 and the rotor disk 6 on the hub 2 and the vehicle axle 1, as shown in FIG. 2, and to also mount the brake-clamping unit 13 on the brake carrier holder 9 and the vehicle axle 1, the following steps are carried out:

positioning the brake carrier holder 9 on the vehicle axle 1 and welding it in place;

positioning the seal 35 and the pivot bearing 34 on the vehicle axle 1;

positioning the pivot bearing 33 into the wheel hub 2, and then placing this assembly on the vehicle axle 1;

securing with the screw connection 46, then installing the cover 36;

connecting the three brake carriers 10 by means of screws 38, 39 to the brake carrier holder 9;

providing the hydraulic ring cylinder 14 with the piston chamber seals 47, 48, and the ring piston 15 including the force transmission ring 20;

inserting the partially prepared brake-clamping unit 13 into the three brake carriers 10;

inserting the first inner friction disk 7, then also inserting the complete rotor disk 6, including the ring-shaped brake linings 11 and 12;

positioning the second outside friction disk 8 on the three brake carriers 10;

placing the force transmission rods 18, and the force transmission ring 19, and attaching them with screws 28: the brake-clamping unit 13 is thereby assembled within itself, as well as being connected non-rotatably to the vehicle axle 1; and

installing the wheel 3, and attaching to the wheel hub 2, via the connection screws 5.

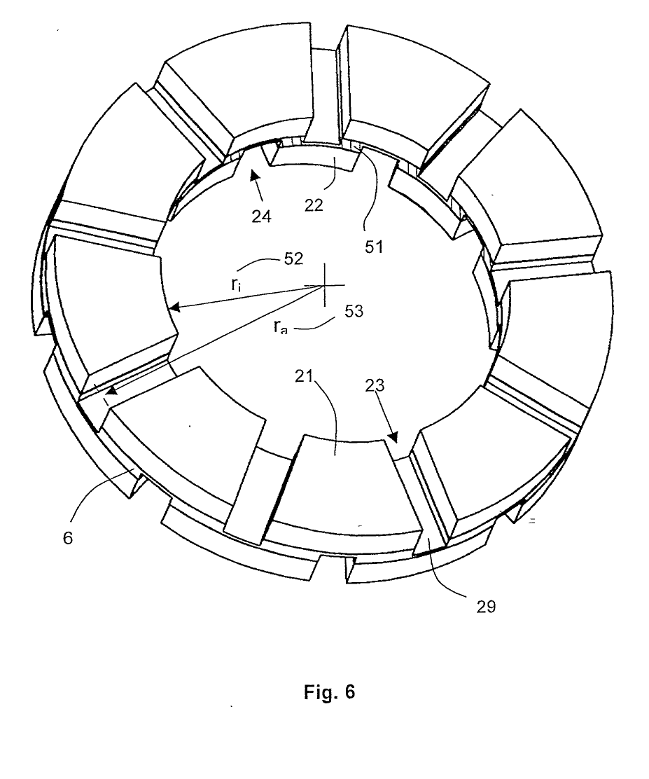

Air-conveying cooling channels are configured between the rotor disk 6 and the friction disks 7, 8, as shown in a perspective drawing in FIG. 6.

To show the air-conveying channels in FIG. 6, the rotor disk 6 is fractured in the area of the inside diameter of the friction disks 7, 8. This produces a hatch-marked surface of the fracture 51. Nine air-conveying channels are provided in the rotor disk 6 for cooling each friction disk to the outside ambient. There are nine airconveying channels 23 in the direction of the first inside friction disk 7, and nine air-conveying channels 24 in the direction of the second outside friction disk 8 (for the sake of clarity, reference numbers 23 and 24 are shown for only one of the nine air-conveying channels).

Nine free radial recesses 29 are provided (reference number shown on only one example) for the air-conveying channels on the side of the rotor disk 6 pointing to the first friction disk 7, and serve as a base for the air-conveying channels 23 extending towards the first inside friction disk 7. The lateral limit surfaces defined by these radial recesses 29 extend through the ring-shaped brake lining to the friction disk 7 (except for the venting clearance present in the non-braked state). Identical radial recesses are also provided on the side of the rotor disk 6 pointing in the direction of the second outside friction disk 8. The lateral delimiting surfaces of the air-conveying channels 23 and 24 are straight surfaces, corresponding to these radial recesses.

Due to the design of the air-conveying channels 23, 24, the brake linings 11, 12 are configured as nine brake lining segments 21, 22, respectively, and are assembled in the form of a circular ring. As shown in FIG. 6, the circular ring area is defined by an inside diameter rᵢ 52 and an outside diameter rₐ 53, within which the brake lining segments 21, 22 are located. The surface of this circular ring area is thus divided into a first surface portion for the brake lining segments 21, 22, and a second surface portion for the air-conveying channels 23, 24. Thus, for the brake linings 11 (or 12), the first surface portion represents the sum of the surfaces of the nine brake lining segments 21 (or 22), and the sum of the base surfaces of the nine air-conveying channels 23 (or 24), makes up the second surface portion.

For further clarification of FIG. 6, it is pointed out that the rotor disk 6 in FIG. 2 is shown in a rotational position where the cut in the upper portion of the drawing goes through a channel 24, and in the lower portion of the drawing, goes through a channel 23. The nine brake lining segments and nine air-conveying channels (21 and 23, or 22 and 24) shown on either side of the rotor disk 6 in FIG. 6, represent one embodiment of the invention. It is also possible to provide a different number of brake lining segments and air-conveying channels for the brake lining 11 pointing to the friction disk 7 than are provided for the brake lining 12 pointing to the friction disk 8.

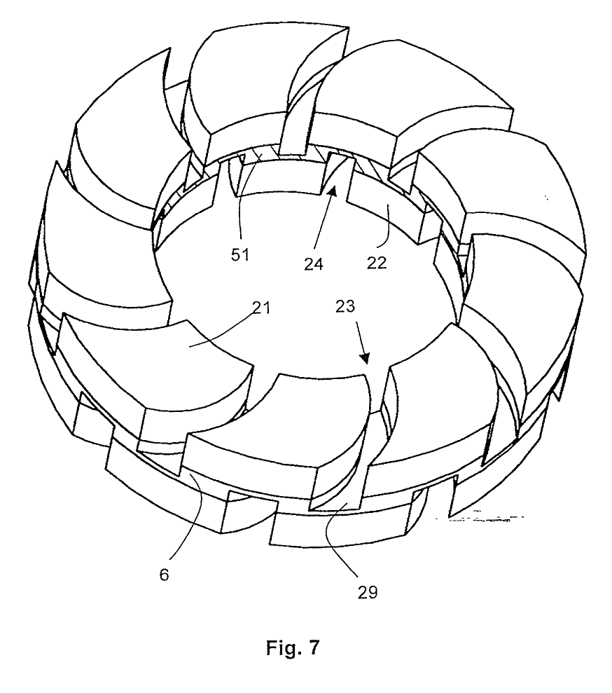

FIG. 7 shows another embodiment of the rotor disk 6, with a different design of the air-conveying channels. Here, the rotor disk 6 is broken up in the same manner as in FIG. 6, and the fractured surface 51 is again indicated by hatch marks.

With respect to the surface relationship, the configuration described in FIG. 6 applies here as well; i.e., the circular ring area defined by the inside diameter rᵢand the outside diameter rₐ (omitted for the sake of clarity in FIG. 7) is divided into a first surface portion for the brake lining segments and into a second surface portion for the air-conveying channels.

In contrast to the air-conveying channels of FIG. 6, the radial recesses 29 in FIG.7 are configured so that the lateral delimitation surfaces are in the shape of curved surfaces. The curved form of these surfaces is designed in accordance with known turbine blade technology, so that as the air moves from the inner to the outer area of the rotor disk 6, the air flow is accelerated.

Thus, for example, the cross-section of an air-conveying channel 23 (or 24) can be made smaller at its radially inner inlet area than at its outlet area, as indicated in FIG. 7, representing the volume increase by heat absorption.

The positioning of the radial recesses 29, which are shown as straight lateral delimitation surfaces in FIG. 6, and as curved lateral delimitation surfaces in FIG. 7, is such that they are offset from each other by an angle position. Corresponding to the nine air-conveying channels on each side, the radial recesses 29 are at angular distances of 60° from each other on the two sides of rotor disk 6. This angular offset results from the fact that the arrangement of nine air-conveying channels on one side is offset by an angle of 30° relative to the positioning of the nine air-conveying channels on the other side.

As a result of this offset of the air-conveying channels, improved cooling of the rotor disk 6 is achieved, because the cooling takes place mainly through convection over the air-conveying channels.

With this arrangement, moreover, a brake lining segment on one side of the rotor disk 6 is placed directly opposite an air-conveying channel on the other side of the rotor disk 6. As such, the air-conveying channel cools by convection an area of the rotor disk 6 which would be heated by the brake lining segment directly opposite the air-conveying channel. Although this brake lining segment will not immediately transfer braking heat to this area of rotor disk 6, due to its poor heat conductivity, the area can heat up in the course of many successive brake actuations. The positioning of the airconveying channel directly opposite the heat-producing brake lining segment, therefore, ensures that braking heat reaching the rotor disk 6 in this manner is rapidly lowered by convection.

In contrast to the poor conductivity of the brake lining segments, the friction disks 7, 8 and the rotor disk 6 possess good heat conductivity. During braking, frictional heat is produced on the friction surfaces between the friction disks 7, 8 and the brake lining segments 21, 22 of the rotor disk 6.

Since the cooling air is brought through the air-conveying channels in the rotor disk 6 directly over the friction surfaces of the friction disks 7, 8, the frictional heat that is built up at its point of generation (brake lining segments 21, 22) remains comparatively very limited.

The brake lining segments 21, 22 also act as heat insulators between the friction surfaces of the friction disks 7, 8 and the rotor disk 6. Therefore, the limited heating of the brake lining segments, in addition to their insulating characteristic, results in a comparatively very limited amount of heating of the rotor disk 6.

The rotor disk 6 is typically made of a metallic material, although this is not absolutely necessary. Since a metal rotor disk has good heat conductivity, it has the potential to damage a wheel hub through overheating. When the rotor disk remains comparatively cool during braking, however, as in the above described embodiment, the wheel hub will not be heated to such an extent that it would be damaged.

The material of the two friction disks 7, 8 must be highly wear-resistant, and must also possess great temperature stability, good heat conductivity, and have as low a specific gravity as possible. Ceramic compounds, in which carbon fiber is embedded into the basic ceramic substance by sintering to improve the elasticity and resistance to thermal shock characteristics, are especially well suited for this application. Friction disks made of this type of material are three times more heat-conductive than, e.g., cast iron, while weighing only half as much, and being practically wear-proof. One suitable ceramic compound material is, e.g., the fiber-reinforced SISIC.

A preferred embodiment of the present invention includes friction disks 7, 8 made of a ceramic compound material, due to the desirable characteristics of the material. In principle, however, the friction disks can be made of other kinds of brake disk materials as well, such as cast steel, cast iron, or ALMMC (disk material on an aluminum base).

The convection cooling by the air-conveying channels 23, 24, as described above, represents a first removal of heat directly from the friction surfaces. A second removal of heat takes place primarily at the lateral peripheries of the friction disks 7, 8, away from the rotor disk 6. These peripheries are essentially uncovered, as indicated by the previously described cooling channels 49 (FIG. 2), and the practically “linear” placement of the piston rod ring 16 and the force transmission ring 19, along the respective circular contact line with the friction disks 7, 8. Heat is removed from these lateral peripheries directly to the ambient air through convection, and the convection is further reinforced by the drive wind. Ceramic material, in addition to its good heat conductivity, also has good heat storage capacity. Therefore, the heat initially transferred into the friction disks is “buffer-stored”, and is then rapidly reduced, in the manner described previously.

It should also be noted that it is possible to provide fluid cooling for the friction disks 7, 8. The fluid cooling channels, each having connections for fluid entry and exit, can be provided in one or both friction disks to constitute a fluid circuit. A fluid cooling channel of this type can be configured, e.g., with a round cross-section, and can be embedded into the friction disk. The channel would extend from the point of fluid entry to the point of fluid exit, and would be in the form of an arc, e.g., over a circumferential angle of 300°, which would almost cover the entire circumference.

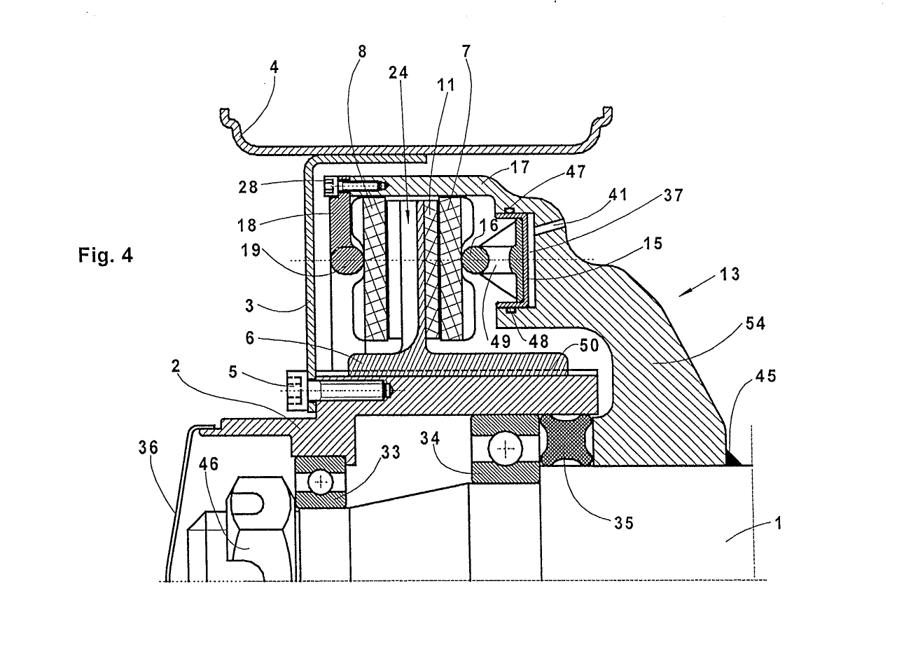

Referring now to FIG. 4, a modified embodiment of the brake-clamping unit 13 (previously shown in the upper portion of FIG. 2) is permanently connected, via an attachment 45, to the vehicle axle 1. It is therefore a 360° fixed saddle around the wheel. Only the upper portion of FIG. 2 is represented in FIG. 4, because the change in the brake-clamping unit 13 is sufficiently described therein.

In this embodiment, the rotor disk 6 is no longer fixedly connected to the wheel hub 2. Instead, it is configured as a sliding element, which is connected non-rotatably via a longitudinal toothing 50, to the wheel hub 2. However, the rotor disk 6 is capable of being displaced in an axial direction. Therefore, with an axially fixed brake-clamping unit 13, the rotor disk 6 can be displaced axially, to compensate for lining wear by increasing advances of the force transmitting ring 20. The brake lining 11 (and 12 in FIG. 2) gradually becomes thinner with wear, which alters its axial position relative to the vehicle axis 1.

In FIG. 4, the brake-clamping unit 13 is made in the form of a brake application unit support 54, which is interlockingly connected via attachment 45 to the vehicle axis 1. The separate hydraulic ring cylinder 14 of FIG. 2 is directly integrated into the brake application unit support 54 of FIG. 4.

The rotor disks previously described in FIGS. 6 and 7 can be installed in the brake-clamping unit of FIG. 4 in the same manner as described for the brake-clamping unit of FIG. 2. Due to the previously explained fractured representation, the differences between the utilization in a brake-clamping unit according to FIG. 2 (rotor disk 6 fixedly connected to the vehicle axis 1), and the utilization of a brake-clamping unit according to FIG. 4 (rotor disk 6 non-rotatably connected via longitudinal toothing 50 to the vehicle axis 1) are not visible in these drawings, since they only relate to that portion of the rotor disk 6 which is eliminated by the fracture.

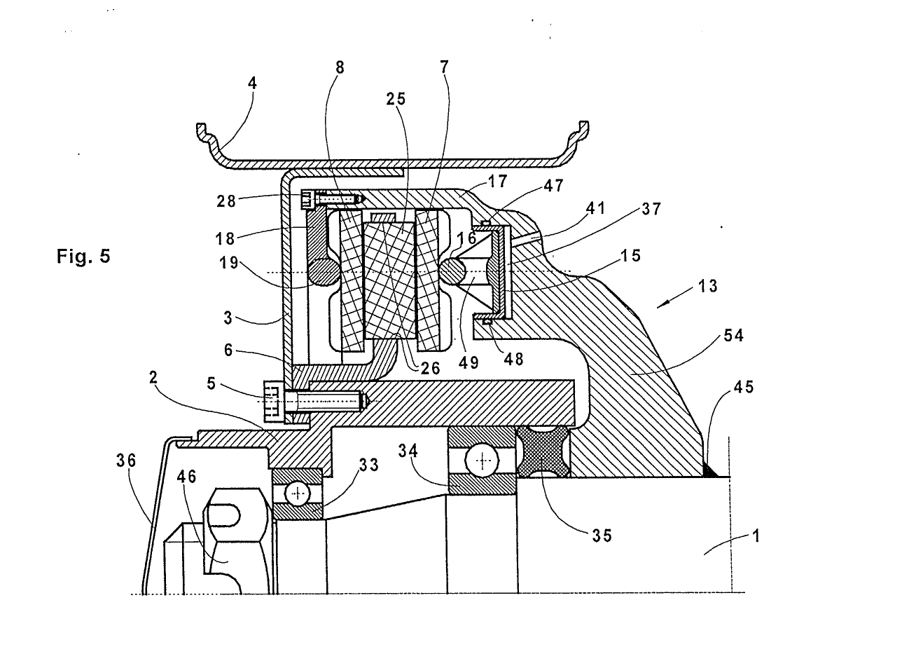

The brake-clamping unit embodiment of FIG. 5 is identical with that of FIG. 4, except that the rotor disk 6 is fixedly connected via connection screws 5 to the wheel hub 2, as in FIG. 2.

Referring again to the embodiment in FIG. 5, the brake lining is configured as plate-shaped components 25, which are located within the rotor disk 6. The brake lining plates 25 are inserted into recesses 26 on the rotor disk 6, and they are mounted non-rotatably in the rotor disk 6, but are capable of axial displacement. As such, the braking moment created through the frictional interlocking of the plates 25 with the friction plates 7, 8 is transmitted to the rotor disk 6. In order to stabilize the form of this embodiment, a supporting sleeve can be provided for each of the brake lining plates 25. These supporting sleeves are interlockingly connected to a corresponding lining plate along its outer contour, and within the range of its axial displacement. As the brake lining plates 25 are displaced, these supporting sleeves establish a sliding contact with the inside contour of the recesses 26 of the rotor disk 6, in which the brake lining plates 25 are mounted.

With the axially fixed brake-clamping unit 13, and the axially non-movable rotor disk 6, the brake lining plates 25 are displaced axially as a result of lining wear caused by repeated activation of the piston rod ring 16. This axial displacement is the compensation for wear, so that the axial position of the brake lining plates 25 changes relative to the vehicle axis 1 as the brake lining plates 25 become thinner with wear.

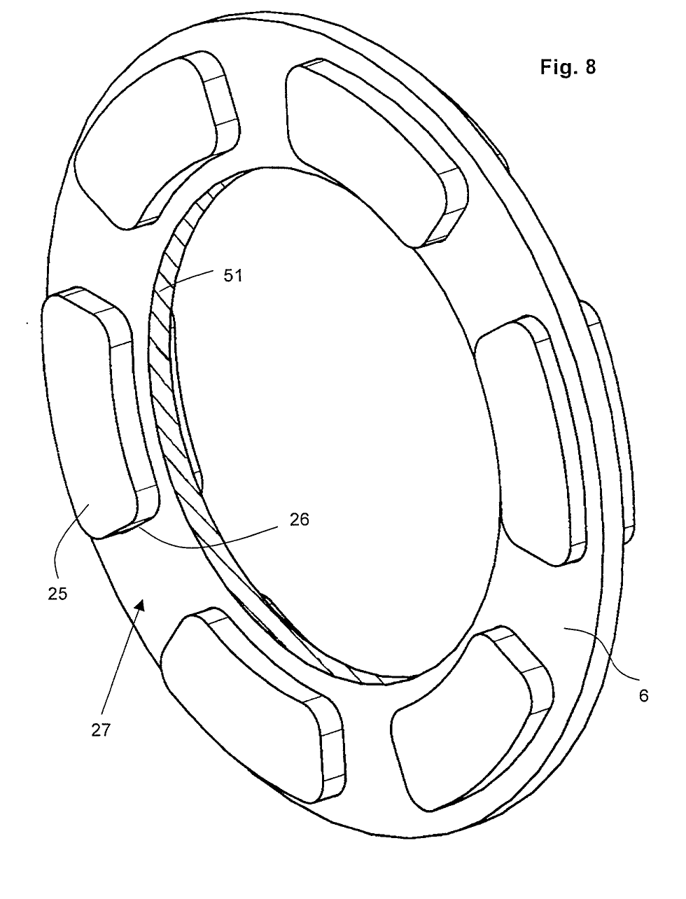

Referring now to FIG. 8, the rotor disk 6, shown in the fractured manner of FIGS. 6 and 7, is configured for the embodiment of the brake-clamping unit 13 of FIG. 5. As illustrated in FIG. 8, the previously described ring-shaped area of the rotor disk 6 has six recesses 26, for receiving the six brake lining plates 25. It can be seen that the brake lining plates 25, which are comparatively broad because of the required reserve for wear, extend on both sides of the comparatively narrow rotor disk 6, so that free intervals 27 are created between all adjoining brake lining plates 25. The brake lining plates 25, the recesses 26, and the free intervals 27 are designated once on the drawing, for one of the six brake lining plates 25. It should be noted also, that instead of six recesses 26, any other number of recesses could be selected, depending on design requirements.

The free intervals 27 constitute air circulation paths between the six brake lining plates 25 and the friction disks 7, 8 when the brake-clamping unit 13 is assembled in accordance with the embodiment of FIG. 5. These air circulation paths are the cooling means for the inventive disk brake. The air circulation paths resulting from the free intervals 27 produce, in principle, the same type of cooling of the rotor disk 6 as was previously explained in connection with the air-conveying channels 23 and 24 of FIGS. 6 and 7. The embodiment of the cooling system of FIG. 8, however, has the advantage that no large-surface connection (e.g., by bonding the brake lining segments 21 or 22 to the rotor disk 6) is used, so that heating of the rotor disk 6 is reduced, as compared to those other embodiments.

Another advantage of the embodiment shown in FIG. 8 is the lower cost of assembly when replacing linings. In this case, the rotor disk 6 need not be disassembled, because the brake lining plates 25 can be inserted therein when the second outside friction disk 8 is removed.

The brake lining plates 25 are economical replaceable spare parts. They can be stored separately, and do not require any additional bonding means to the rotor disk 6. As such, this embodiment of the brake lining plates 25 provides reduced production costs of the rotor disk 6.

Because of the free intervals 27, the brake lining plates 25 cover only part of the surface of the ring-shaped area defined by the inside diameter 52 and the outside diameter 53 ring-shaped area.

As disclosed in the German patent application DE 199 36 394 (incorporated herein by reference) (wherein brake lining 2 of FIG. 9, with a kidney-shaped outer contour, is inserted into a kidney-shaped passage opening 3), the brake lining plates 25 are kidney-shaped. A kidney-shaped configuration of the ring piston 15 offers two advantages:

1) the asymmetry of the kidney shape ensures in a simple manner that it is non-rotatable relative to the rotor disk 6;

2) the kidney shape corresponds approximately to the rotational movement of the rotor disk 6, so that there is an improvement in wear behavior.

It should also be noted that it is feasible to provide only one friction disk (7 or 8) with any of the aforementioned embodiments, whereby the cooling means would then be located in the area between the rotor disk 6 and this one friction disk.

In short, a full disk brake arrangement is disclosed which reduces the heating of the rotor disk and wheel hub by directing air cooling to the source of the frictionally generated heat.

While the invention has been described by reference to specific embodiments, this was for purposes of illustration only and should not be construed to limit the scope of the invention. Numerous alternative embodiments will be apparent to those skilled in the art.

1. A full disk brake for braking a vehicle, comprising:
a. a rotor disk, connected non-rotatably to a wheel of said vehicle, said wheel being mounted rotatably on an axle of said vehicle,
b. a brake-clamping unit, connected to said axle,
c. at least one friction disk, secured in a rotational direction within said brakeclamping unit, and displaceable in an axial direction,
d. at least one brake lining component comprising a separate mechanical part, installed non-rotatably within a ring-shaped area on said rotor disk, and
e. a cooling arrangement, located in an area between said rotor disk and said at least one friction disk,
wherein an actuation of said brake-clamping unit causes an interlocking friction connection to take place between said rotor disk and said at least one friction disk, and wherein said cooling arrangement directs cooling air to said interlocking friction connection.

2. The full disk brake of claim 1 wherein said brake-clamping unit comprises a floating, orbiting saddle around said axle.

3. The full disk brake of claim 1 wherein said at least one brake lining component is positioned in an area between said rotor disk and said at least one friction disk.

4. The full disk brake of claim 1 wherein said cooling arrangement comprises:
f. a plurality of air cooling channels configured as recesses in said rotor disk,
g. said air cooling channels being open to ambient air, and extending in the direction of said at least one friction disk,
h. said at least one friction disk being a delimitation surface for said air cooling channels.

5. The full disk brake of claim 4, wherein:
i. said at least one friction disk comprises first and second axially displaceable friction disks, which are secured in a rotational direction,
j. said air cooling channels are configured as recesses on first and second sides of said rotor disk, said recesses extending from each side of said rotor disk in a direction towards a corresponding one of said first and second friction disks,
k. said first and second friction disks being delimitation surfaces for said air cooling channels.

6. The full disk brake of claim 4 wherein said at least one brake lining component comprises at least one brake lining segment fixedly connected to said rotor disk, said brake lining segment covering a first surface portion of said rotor disk within said ring-shaped area.

7. The full disk brake of claim 6 wherein said air cooling channels cover a second surface portion of said rotor disk within said ring-shaped area.

8. The full disk brake of claim 7 wherein said first and second surface portions cover the entire surface of said ring-shaped area on said rotor disk.

9. The full disk brake of claim 8 wherein the delimitation surfaces of said recesses in said rotor disk comprise flat surfaces.

10. The full disk brake of claim 9 wherein the delimitation surfaces of said recesses in said rotor disk extend into the area of said brake lining segment.

11. The full disk brake of claim 10 wherein said recesses are open to the ambient, and are positioned on opposite sides of said rotor disk, said recesses on a first side of said rotor disk being oriented at angles offset from corresponding angles of said recesses on a second side of said rotor disk.

12. The full disk brake of claim 8 wherein the delimitation surfaces of said recesses in said rotor disk comprise curved surfaces.

13. The full disk brake of claim 12 wherein the delimitation surfaces of said recesses in said rotor disk extend into the area of said brake lining segment.

14. The full disk brake of claim 13 wherein said recesses are open to the ambient, and are positioned on opposite sides of said rotor disk, said recesses on a first side of said rotor disk being oriented at angles offset from corresponding angles of said recesses on a second side of said rotor disk.

15. The full disk brake of claim 1 wherein said at least one brake lining component comprises a plurality of brake lining components mounted on said rotor disk so as to be axially displaceable relative to said rotor disk.

16. The full disk brake of claim 15 wherein:
said brake lining components comprise brake plates;
said cooling arrangement comprises a plurality of air cooling channels comprising air circulation paths, constituted by free intervals between said brake lining components;
said at least one friction disk secured in a rotational direction comprises a delimitation surface of said air circulation paths in a direction away from said rotor disk.

17. The full disk brake of claim 16 wherein:
said at least one friction disk comprises first and second friction disks secured in a rotational direction and axially displaceable relative to said rotor disk;
said air circulation paths open to the ambient are located on first and second sides of said rotor disk; and
said first and second friction disks secured in a rotational direction comprise delimitation surfaces of said air circulation paths in a direction away from said rotor disk.

18. The full disk brake of claim 16 wherein said brake plates cover part of the surface of said ring-shaped area on said rotor disk.

19. The full disk brake of claim 1 wherein said at least one friction disk is made of a ceramic material.
